(19) United States
(12) Patent Application Publication
(10) Pub. No.: US 2026/0254217 A1
(43) Pub. Date: Aug. 27, 2026

(54) LOW PROFILE CANOPY FOR ELECTRICAL DEVICES SUCH AS LIGHTING AND LIGHTING FIXTURES

(71) Applicant: Bocci Design & Manufacturing, Inc., Vancouver (CA)

(72) Inventors: Randall Bishop, Vancouver (CA); Patrick Mulcahy, Vancouver (CA); Vincent Lin, Vancouver (CA)

(73) Assignee: Bocci Design & Manufacturing, Inc., Vancouver (CA)

(21) Appl. No.: 19/545,232

(22) Filed: Feb. 20, 2026

Related U.S. Application Data
(60) Provisional application No. 63/761,350, filed on Feb. 21, 2025.

(51) Int. Cl. H02G 3/20; F21V 27/02

(52) U.S. Cl. CPC H02G 3/20; F21V 27/02

(57) ABSTRACT

Mounting devices for electrical fixtures have a hollow housing having an entrance end and an opposing exit end, exterior threading configured to engage a building material, and interior threads, and having a faceplate as a head of a threaded stem. The threaded stem has a bore therethrough in the longitudinal direction and is threadingly engaged with the interior threads of the hollow housing. The mounting devices can have a housing defining a cavity. The housing has a first end with interior threads and an opposing second end having a through hole and exterior threads, an insulating lining in the cavity, a strain relief collar seated in the cavity and operatively connected to a wire or cable for an electrical fixture, a wiring connector, and a cap with a faceplate having a threaded stem that is removably threaded to the interior threads of the hollow housing.

### RELATED APPLICATIONS

This application claims the benefit of U.S. Provisional Application No. 63/761,350, filed Feb. 21, 2025, which is incorporated herein by reference in its entirety.

### TECHNICAL FIELD

This application relates to a low-profile interior mounting system for electrical lights, electrical light fixtures, or other electrical devices.

### BACKGROUND

Existing electrical interface systems for powering appliances, such as lighting systems and chandeliers, lack integration into architectural designs, detracting from the overall aesthetic and artistic appeal of electrical installations. These systems are primarily high voltage and lack flexibility in terms of electrical connection during installation and may present unsightly distractions in the form of electrical outlets, junction boxes, and other evidence of electrical connections.

As such, there is a need for a new method and system for structurally supporting while simultaneously providing the electrical power to electrical devices, such as light fixtures, especially those that use class 2 or class 3 power supplies. Moreover, there is a need for system that mitigates visual clutter within a given spatial context for class 2 and class 3 power systems, especially one that provides seamless integration with a substrate, which provides an installer flexibility in determining optimal placement of one or more light fixtures, especially a plurality of light fixtures forming a single visual effect. Also, class 2 and class 3 power supply systems minimize the necessity for high voltage wiring (thereby reducing copper consumption) and junction boxes.

### SUMMARY

In one aspect, mounting devices for electric fixtures are disclosed herein. The mounting devices have a hollow housing that has an entrance end and an opposing exit end, exterior threading configured to engage a building material, and interior threads. The mounting devices have a faceplate as a head of a threaded stem. The threaded stem has a bore therethrough in the longitudinal direction and is threadingly engaged with the interior threads of the hollow housing. The distal end of the threaded stem can extend beyond the opposing exit end.

The mounting device can also include a wire passing through the bore of the threaded stem and a strain relief collar connected to the wire and seated against the distal end of the threaded stem. The strain relief collar can have an elongate body defining a through hole having a plastic insert seated therein. The elongate body can have a threaded hole oriented transverse to a longitudinal axis thereof and a set screw threaded into the threaded hole. The plastic insert can have a radially outward extending flange at a first end which is seated against a first end of the elongate body. In one embodiment, the wire terminates with an electric outlet configured to receive a plug of an electrical light or electrical light fixture

In some embodiments, the hollow housing can be shaped as a frustum of a cone. In one embodiment, the faceplate comprises a recess shaped to receive a tool for rotating the threaded stem. The faceplate is a low-profile canopy for a light fixture.

In another aspect, the mounting devices for electrical fixtures have a hollow housing defining a cavity and having a first end comprising interior threads and an opposing second end having a through hole, and having exterior threads configured to engage a building material, an insulating lining in the cavity, a strain relief collar seated in the cavity and operatively connected to a wire or cable for an electrical fixture, a wiring connector, and a cap that has a faceplate having a threaded stem protruding therefrom that is removably threaded to the interior threads of the hollow housing. The threaded stem has a bore therethrough in the longitudinal direction.

The faceplate can have a recess shaped to receive a tool for rotating the threaded stem of the cap. In one embodiment, the insulting lining is a coating applied to the interior surface of the mounting cavity. In another embodiment, the insulting lining is an insert that is seated against the interior surface of the mounting cavity. The insert can be contoured to mate with the interior surface of the mounting cavity and has an aperture aligned with the through hole of the second end. In all embodiments, the insert can be or include an elastomeric material. The insert can terminate with an inward tapered neck that has an annular collar extending therefrom.

In all embodiments, the strain relief collar can have an elongate body defining a through hole having a plastic insert seated therein. The elongate body can have a threaded hole oriented transverse to a longitudinal axis thereof and a set screw threaded into the threaded hole. The plastic insert can have a radially outward extending flange at a first end which is seated against a first end of the elongate body.

In all embodiments, the electrical wire can be a class 2 or class 3 power electrical wire.

### BRIEF DESCRIPTION OF THE DRAWINGS

A better understanding of the features, advantages and principles of the present disclosure will be obtained by reference to the following detailed description that sets forth illustrative embodiments, examples of which are additionally illustrated in the accompanying drawings. In the drawings like reference numbers indicate identical or functionally similar elements.

FIG. 1 is an exploded perspective view of a first embodiment of a mounting device having a low-profile planar canopy for an electrical device, such as a light or light fixture.

FIG. 2 is a longitudinal cross-section of the embodiment of FIG. 1 in an assembled and mounted state.

FIG. 3 is an exploded perspective view of the housing of the first embodiment.

FIG. 4 is a side perspective view of an embodiment of the housing showing a tool adapter receivable in the open end of the housing.

FIG. 5 is an exploded perspective view of the first embodiment showing details of the strain relief collar and the strain relief bushing.

FIG. 6 is a schematic view of the strain relief collar and its assembly.

FIG. 7 is an exploded, side perspective view of a second embodiment of a mounting device having a low-profile planar canopy for an electrical device.

FIG. 8 is photograph of an alternate embodiment for the hollow housing.

FIG. 9 is a photograph of the embodiment of FIG. 8 installed in a building material, more particularly, drywall board.

FIG. 10 is a photograph of the installed mounting device of FIG. 7 from the back side showing the strain relief collar.

FIG. 11 is a longitudinal cross section through screw-like member of the mounting device at a tool recess.

FIG. 12 is an exploded, side perspective view of a third embodiment of a mounting device having a low-profile planar canopy for an electrical device.

FIG. 13 is a longitudinal cross-section of the third embodiment in an assembled and installed state.

FIG. 14 is an exploded, side perspective view of a fourth embodiment of a mounting device having a low-profile planar canopy for an electrical device.

FIG. 15 is a longitudinal cross-section of the fourth embodiment in an assembled and installed state.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

As used herein “low-profile” means the mounting and electrical connection of the canopy is made within or flush to the ceiling. It is a flat and unobtrusive install with minimal thickness in this case the cap sits no further than 3 mm from the face of the mounting surface.

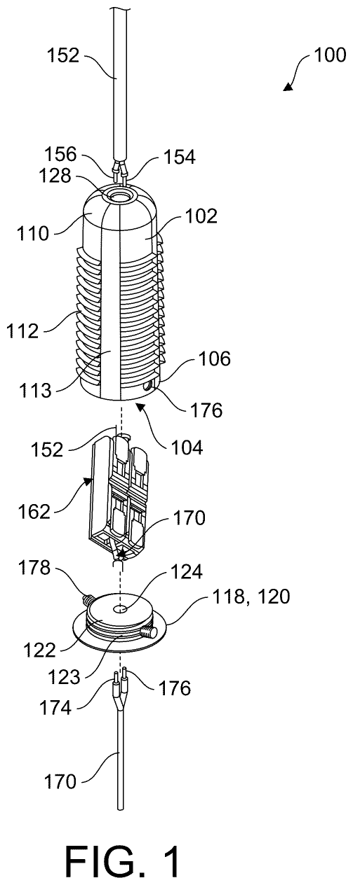

FIGS. 1-5 show a mounting device 100 for an electrical fixture. The electrical fixture can be an electrical light, an electrical charging port, power supply, typically for mounting in the interior of a room or building. The mounting device 100 has a hollow housing 102 defining a mounting cavity 104 and having a first end 106 comprising interior threads 108 and an opposing second end 110 and having exterior threads 112 configured to engage a building material. The exterior threads 112 of the hollow housing 102 can be discontinuous, in that it can have one or more elongate voids 113 spaced apart periodically about the circumference thereof. The mounting device 100 has an insulating lining 114 in the mounting cavity 104 and a wiring connector 162 removably seatable in the mounting cavity 104. The mounting device 100 has a cap 118 that has a faceplate 120 having a threaded stem 122 protruding therefrom that is removably threaded via threads 123 to the interior threads 108 of the hollow housing 102. The threaded stem 122 has a bore 124 therethrough in the longitudinal direction.

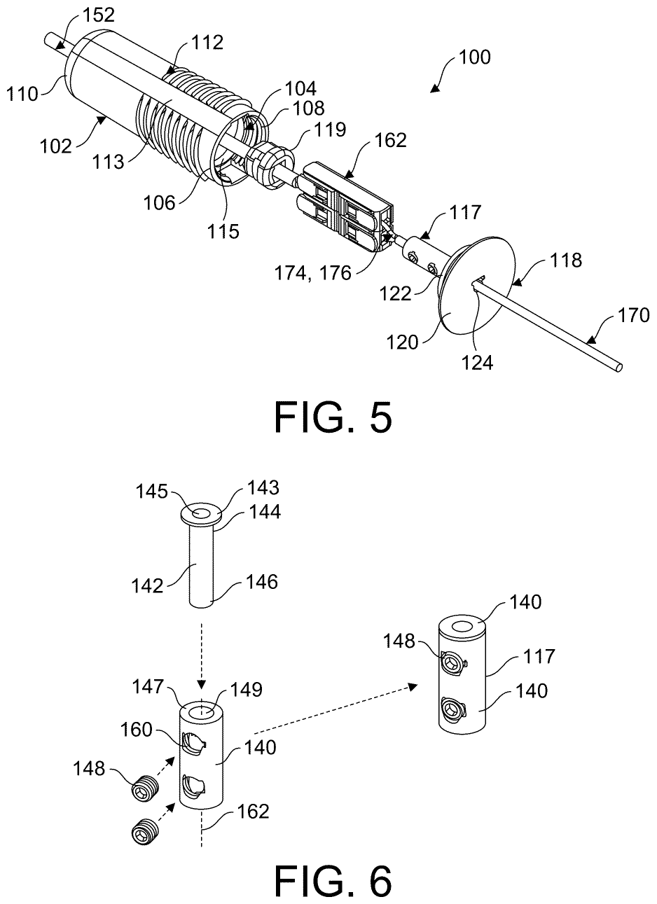

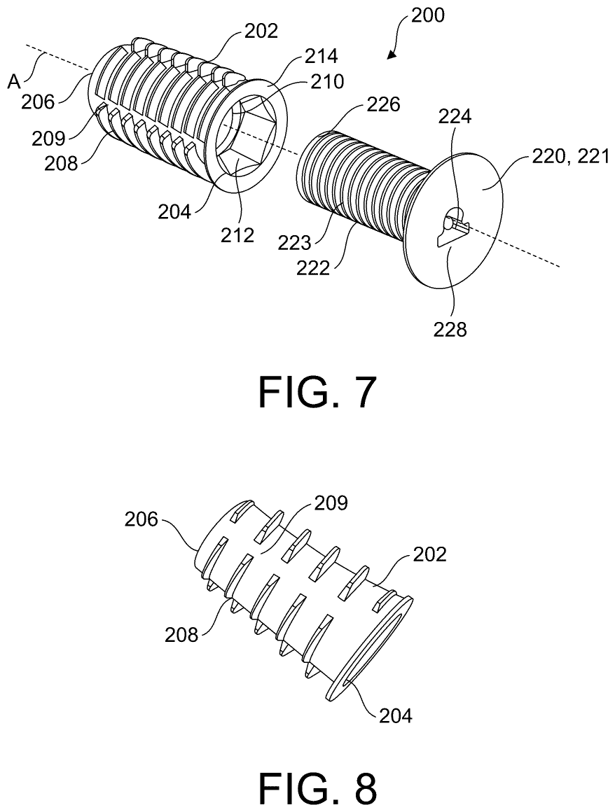

The cap 118 may be rotated by the fingers of the user or the cap can include a tool recess or other feature as shown in FIGS. 5, 7, or 11 to aid in threading the cap into the hollow housing 102. When the cap 118 can be rotated by the fingers of the user, i.e., requiring no tools, this provides a user-friendly, fast, and easy to maintain mounting device and the electrical fixture operatively attached thereto. This can reduce downtime and reduce maintenance costs.

Still referring to FIGS. 1-5, the hollow housing 102 can be generally cylindrical in shape. The hollow housing 102 and the cap 118 can be made of a metal or metal alloy. The metal or metal alloy may be selected from the group consisting of stainless steel, aluminum, carbon steel, or plastic. The hollow housing 102 with the insulating liner 114 functions as a junction box; hence, no other junction box is required for the installation of the electrical fixture. The “integrated” junction box is a huge advantage-it allows mounting directly to the substrate inside a room without the need to remove excess material from a surface thereof (a wall, a ceiling, a floor, etc.) for junction or splice boxes. Thus, there is little to no post-installation refinishing required for the surface of installation, which minimizes disruption, saves time, and reduces the need for specialized skills or equipment, thereby reducing the cost of installation.

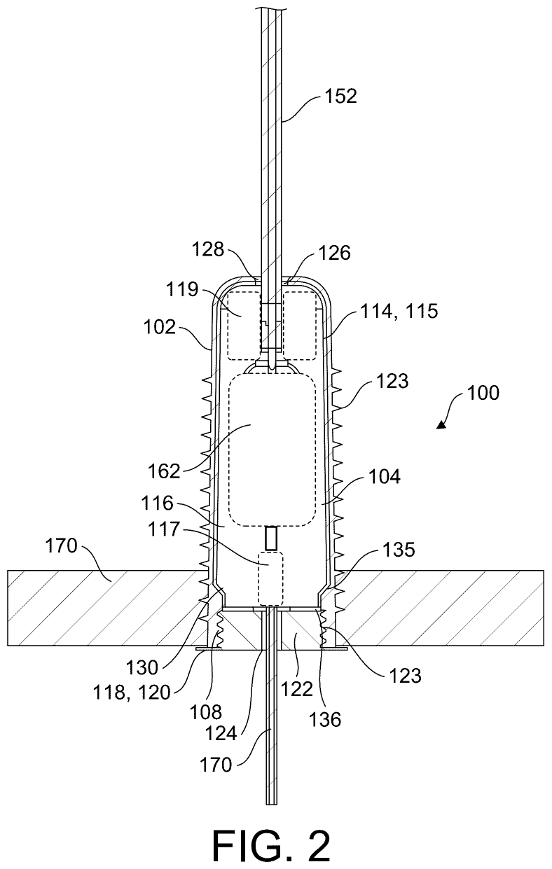

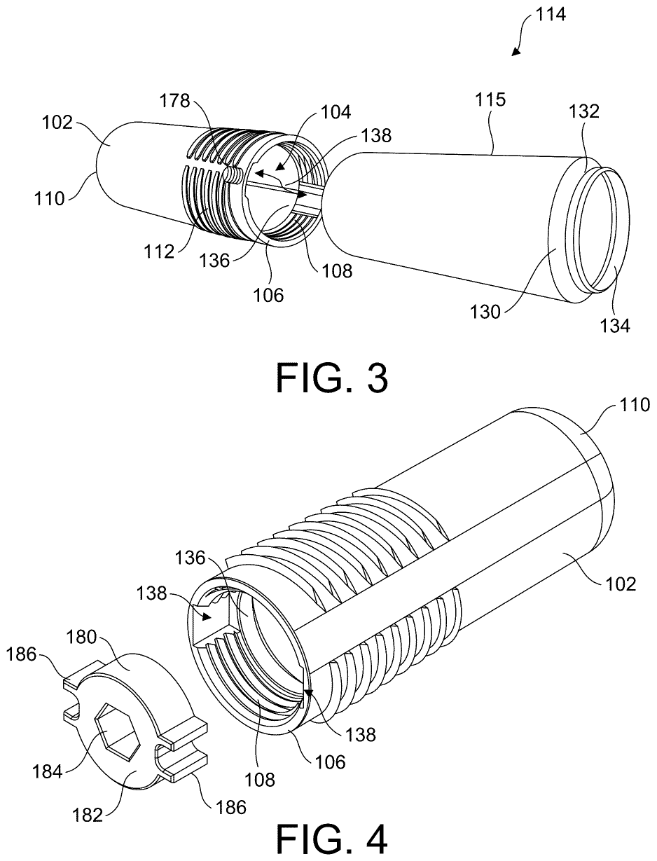

The insulating lining 114 can be a coating applied to the interior surface or an insert 115 (as best seen in FIGS. 2 and 3) that is seated against the interior surface of the mounting cavity 104. The insert 115 is contoured to mate with the interior surface of the mounting cavity 104 and has an aperture 126 aligned with the throughhole 128 of the second end 110 of the hollow housing 102. The insert 115 comprises an elastomeric material, such as rubber, or silicone. The insert 115 terminates with an inward tapered neck 130 that has an annular collar 132 extending therefrom, in the axial direction away from the aperture 116. The collar 132 defines the open end 134 of insert 115. The interior surface of the mounting cavity 104 of the hollow housing 102 has the reverse taper to that of the tapered neck 130 of the insert 115. The reverse taper is immediately adjacent to the interior threading and the interior threading defines the lip 136 upon which the open end 134 is seated.

The insulating lining can be a plastic material or any other material suitable for insulating metal and wires so that the electric current is not transferred through the hollow housing 102. In one embodiment, the insulating lining is made of silicone.

With reference to FIGS. 2 and 5, the mounting device 100 includes a strain relief apparatus to manage and support the weight of the electric fixture. The strain relief apparatus is connected to wire 170 and can include a strain relief collar 117 and/or a strain relief bushing 119. The strain relief collar 117 is positioned between the wiring connector 162 and the cap 118. The strain relief bushing 119 is positioned between the wiring connector 162 and the interior of the hollow housing 102.

The strain relief collar 117, shown in detail in FIG. 6, includes an elongate hollow housing 140 into which a plastic insert 142 is seatable. The plastic insert 142 has a radially outward extending annular flange 143 at a first end 144 thereof. The hollow bore 145 of the plastic insert 142 is configured to receive and have pass therethrough the wiring 152. During assembly, the second end 146 of the plastic insert 142 is inserted into the bore 149 of the elongate hollow housing 140 with its annular flange 143 seated against the end surface 147 defined by a first end of the elongate hollow housing 140. The elongate hollow housing 140 includes at least one threaded hole 160 oriented transverse to the central longitudinal axis 162. The threaded hole 160 is configured to receive a set screw 148. The set screw 148 during assembly will engage the plastic insert 140 and clamp it onto the wiring 152.

In one embodiment, the plastic insert 142 is a piece of plastic tubing made form a material selected from the group consisting of cellulose acetate butyrate (Cab), polyvinyl deneflo (PVDF), polypropylene, high density polyethylene, acrylonitrile butadiene styrene (ABS), polyethylene terephthalate polyester, and combinations thereof. As described above, the plastic tubing has a radially outward extending flange at one end and the other end can have an outer diameter of about 3 mm to about 6 mm, preferably about 4 mm, and a thickness of about 0.1 to about 0.4 mm, more preferably about 0.2 mm. In all embodiments, the plastic insert 142 can absorb energy and plastically deform without fracture. It is advantageous because it can be a thin sleeve of material yet not break under the pressure asserted thereon by the set screw 148. This allows the strain relief device to be small enough to be compatible with the flush canopy system described herein. Moreover, the strain relief device 100 enables the wiring 152 to be the actual cable supporting a pendant light fixture or other electronic device as well as providing its electrical power. In all embodiments, the wiring 152 can be a braided cable (neutral wire) and the plastic insert 142 protects the neutral wire from shorting out on the internal aircraft cable (lead wire) when the set screws are engaged. The plastic insert 142 can be a molded or extruded plastic tube.

In one embodiment, the plastic insert 142 is made of polypropylene. The polypropylene sleeve protects the outer casing of the wiring 152 from engagement or damage thereto by the set screws. The polypropylene can have a density in a range 0.88 to 0.93 g/cc and a tensile strength in a range of 25-42 MPa, as measured by ISO 527-1 (general principles) and ISO 527-2 (test conditions for molding and extrusion materials), both of which are incorporated herein by reference.

The strain relief bushing 119 can be a commercially available strain relief bushing that is configured for the shape of the wiring being used to wire the electrical fixture. In one embodiment, the strain relief bushing 119 can be a RDD LOCKIT™ brand strain relief bushing from the HEYCO Company, which self-locks onto the cable. The strain relief bushing installs easily with fingertip pressure into a standard round or Double D hole. The strain relief bushing protects electric/electronic products by absorbing the forces of push and pull that may be exerted on the wiring.

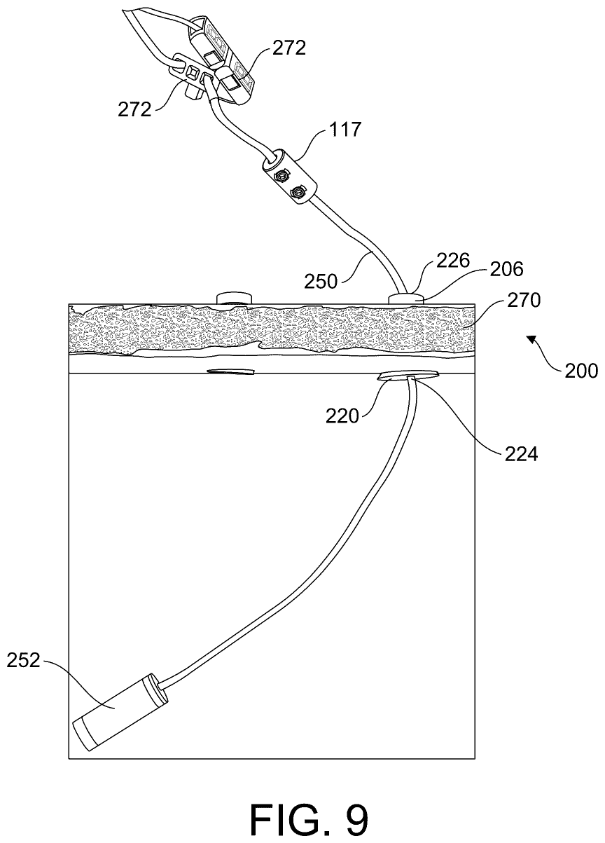

With reference to FIGS. 1, 2 and 5, wiring 152 from a power source enters the hollow housing through the throughhole 128 in the hollow housing and is secured to a wiring connector 162. The other wiring 170, for connection to an electrical fixture, is fed through the through hole 124 in the cap 118 and its individual wires 172, 174 are available for connection to wires 154, 156, respectively via the wiring connector 162. The wiring connector 162 can be a twist-type electrical connector cap or a WAGO® brand electrical connector, such as a WAGO® brand inline splicing connectors as represented in the drawing. The wiring 170 once fed through the throughhole 124 of the cap is also received in the strain relief collar 140. More specifically, the wiring 170 is fed through the bore 145 of the plastic insert 142 and the plastic insert 142 is secured thereto by one or more set screws 148. The wiring 170 can terminate, at an end opposite the wiring connector 162, with a receptacle (see FIG. 9) configured to connect to an electrical fixture.

Referring to FIGS. 1 and 3, optionally, in drywall construction, once the cap 118 is threaded to the hollow housing 102, one or more set screws can be used. The hollow housing 102 can include one aperture 176 for each set screw 178 present.

With reference to FIGS. 1-5, in one embodiment, the faceplate 120 has a diameter of about 3.5 cm and a thickness of 1 mm, and the hollow housing has a length of about 7 cm. This is just an example and is not intended to be limiting. The faceplate 120 can be any shape, including but not limited to oval, square, rectangular, pentagonal, hexagonal, heart-shaped, etc.

The mounting device 100 provides a discreet and visually unobtrusive installation, and the hollow housing 102 with the insulating lining 114 mounts directly to the substrate, thereby pushing the connections into the mounting cavity 104 and allowing a near-flush installation.

For installation purposes, with reference to FIGS. 3 and 4 for understanding, the hollow housing 102 can include a tool feature 138 in the interior of the hollow housing at the first end 106. The tool feature 138 is shown as opposing recesses in the wall defining the interior threads 108. A tool (not shown) or a tool adapter 180 configured to receive a tool can be inserted into the open end of the hollow housing in engagement with the opposing recesses 138 to enable rotation of the hollow housing 102 into a substrate to enable the exterior threads 123 to bite into the substrate. The tool adapter 180 has a body 182 defining a tool receptacle 184 and has opposing protrusions 186 extending radially outward therefrom. The opposing protrusions 186 are configured to slide into the tool feature 138 when the tool adapter 180 is seated in the open first end 106. The tool adapter 180 is seated against a lip 136 within the hollow housing 102.

Any of the wires herein can be coaxial cables or parallel wires inside a casing. In one embodiment, the wiring has a central insulated wire encased in a conductive metal mesh, braided, or twisted casing, which acts as the second wire. In one embodiment, the wiring is a central insulated steel “aircraft cable” encased in a braided metal casing, which does not have electrical power capability. This aircraft cable has a ball at its first end, the end seated in the mounting device, and has a grip lock feature at its second end, which is connectable to a pendant light's hardware. The aircraft cable may be sculptural cable for creature of unique pendent light arrangements.

Turning now to FIGS. 7-9, a mounting device 200 is shown in unassembled and installed variations. The mounting device 200 has a hollow housing 202 that has an entrance end 204 and an opposing exit end 206, exterior threads 208 configured to engage a building material, and interior threads 210. The hollow housing 202 can also have a radially protruding, annular flange 214 on the entrance end 204. The annular flange 214 can determine or limit the mounting depth for the hollow housing 202, by seating against a building material, such as the drywall board 270 shown in FIG. 9. The interior mouth surface 212 of the hollow housing 208 can be contoured and/or shaped to receive a tool that will enable a user to rotate the hollow housing 202 to threadingly engage the same with a building material during installation. As seen in FIGS. 7 and 8, the threading 208 on the exterior of the hollow housing 202 can be discontinuous, in that it can have one or more elongate voids 209 spaced apart periodically about the circumference thereof. The hollow housing 202 can be generally cylindrical as shown in FIG. 7 or its exterior shape can be a frustum of a cone as shown in FIG. 8.

As best seen in FIGS. 7 and 8, the mounting device 200 has a flat planar canopy 220 as a head 221 of a threaded stem 222 having threads 223. The threaded stem 222 has a bore 224 therethrough in the longitudinal direction, see the longitudinal axis A. The bore 224 is aligned with the longitudinal axis and has a distal end 226 opposite the head 221, which defines the first end of the screw-like structure. The flat planar canopy 220 comprises a recess 228 shaped to receive a tool for rotating the threaded stem. In FIGS. 7 and 11, the recess 228 is generally rectangular in shape and is configured to receive the tip of a flathead screwdriver to aid in installing the part. The recess 228 extends from the face plate into the surface thereof to a depth of about 4 mm or less. As shown in FIG. 7, the recess 228 can intersect the bore 224.

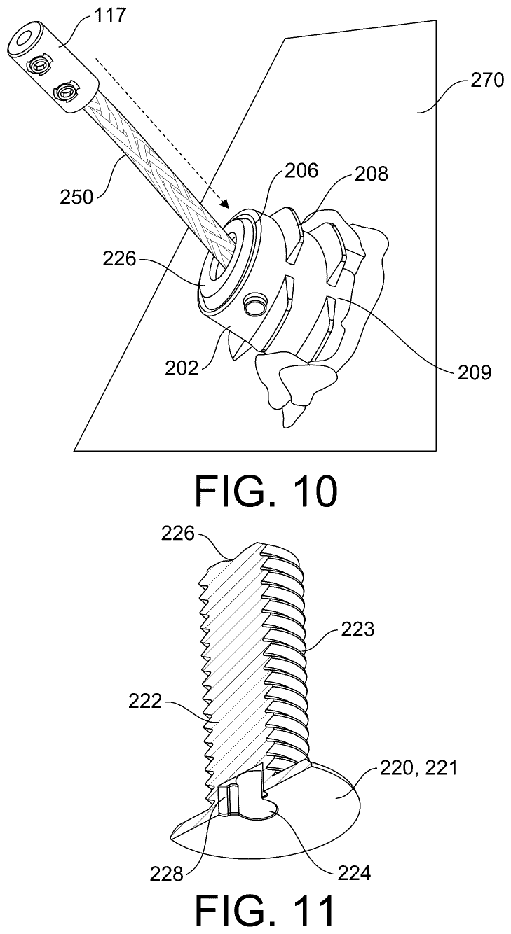

Turning now to the installed and assembled view of FIGS. 9 and 10, the hollow housing 202 has been threaded into an aperture in the building material 270 and the threaded stem 222 of the screw-like member is threadingly engaged with the interior threads 210 of the hollow housing 202. The distal end 226 of the threaded stem 222 is seated such that it extends beyond the opposing exit end 206 of the hollow housing 202 (best seen in FIG. 10). A wire 250 is fed into the bore 224 of the screw-like member and passes therethrough. The wire 250 can be standard wiring for 120 volts or it can be for class 2 or class 3 wiring. In one embodiment, the wiring is a metal mesh wrapped wire. In another embodiment, the wire comprises a plurality of twisted metal wires, each in their own plastic casing housed together inside a larger plastic casing. In the embodiment of FIG. 9, the wire terminates with an electrical outlet 252 configured to receive a plug of an electrical light or electrical light fixture. The electrical outlet 252 can be a canister shaped body that terminates with an outlet configured for connection to an electrical light or electrical light fixture.

Referring to FIGS. 8-10, the system includes the strain relief collar 117 as discussed with respect to the first embodiment, which was shown in detail in FIG. 6. The strain relief collar 117 is connected to the wire 250 and seated against the distal end 226 of the threaded stem 222.

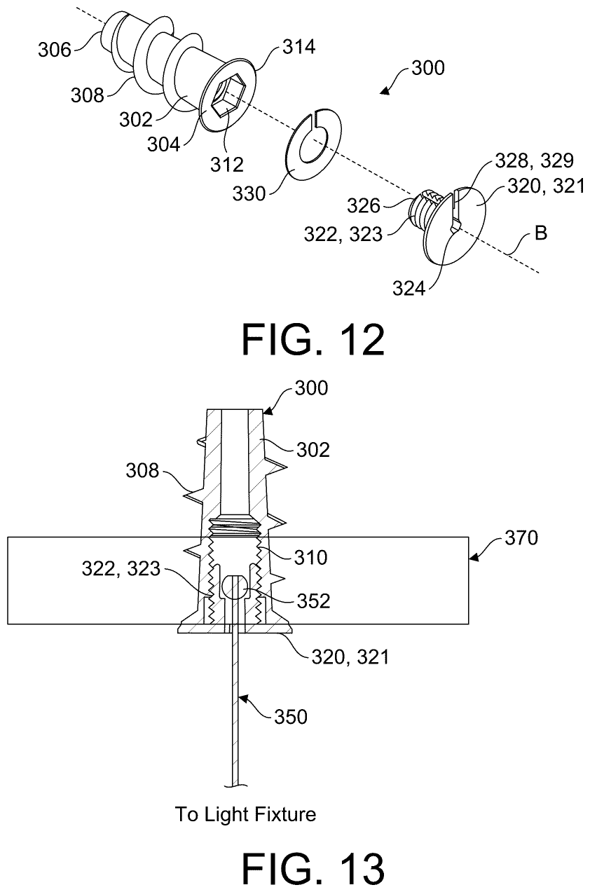

Turning now to FIGS. 12 and 13, a mounting device 300 for wood or drywall structures is shown. The mounting device 300 has a hollow housing 302 that has an entrance end 304 and an opposing end 306, exterior threads 308 configured to engage a building material, and interior threads 310 configured to receive a canopy 320. The hollow housing 302 can also have a radially protruding, annular flange 314 on the entrance end 304. The annular flange 314 can determine or limit the mounting depth for the hollow housing 302, by seating the annular flange 314 against a building material, such as the drywall board 370 shown in FIG. 13. The interior mouth surface 312 of the hollow housing 308 can be contoured and/or shaped to receive a tool that will enable a user to rotate the hollow housing 302 to threadingly engage the same with a building material during installation. The hollow housing 302 can be generally cylindrical or its exterior shape can be a frustum of a cone as shown in FIGS. 12 and 13.

The mounting device 300 has a flat planar canopy 320 as a head 321 of a threaded stem 322 having threads 323. The canopy 320 has a bore 324 therethrough in the longitudinal direction, see the longitudinal axis B. The bore 324 is aligned with the longitudinal axis and has a distal end 326 opposite the head 321, which defines the first end of the screw-like structure. The canopy 320 comprises a recess 328 shaped to receive a tool for rotating the threaded stem, which in this embodiment is shown as a slot 329 extending radially outward from the bore 324. As best seen in FIG. 12, the slot 329 can extend axially through the entire body of the canopy 321. The slot 329 is configured to receive the tip of a flathead screwdriver or the like to aid in installation.

The mounting device 300 can also include an annular pad 330 seatable against the annular flange 314 of the hollow body 302 before the canopy 320 is threadingly inserted therein. In one embodiment, the annular pad 330 is made of Teflon.

Turning now to the installed and assembled view of FIG. 13, the housing 302 has been threaded into an aperture in the building material 370 and the threaded stem 322 of the screw-like member is threadingly engaged with the interior threads 310 of the hollow housing 302. The bore 324 is generally hexagonally-shaped to receive an aircraft cable 350, which is described above. The aircraft cable 350 has a ball at its first end, the end seated in the mounting device, and has a grip lock feature (not shown) at its second end, which is connectable to a pendant light's hardware. Since the aircraft cable 350 has the ball 352 at its first end, the slot 329 in the canopy 320 may also enable the aircraft cable to be inserted into the canopy. Alternately, the mounting device 300 can be used in the same manner as described above with respect to the embodiment of FIGS. 9 and 10 if class 2 or class three power wiring is needed.

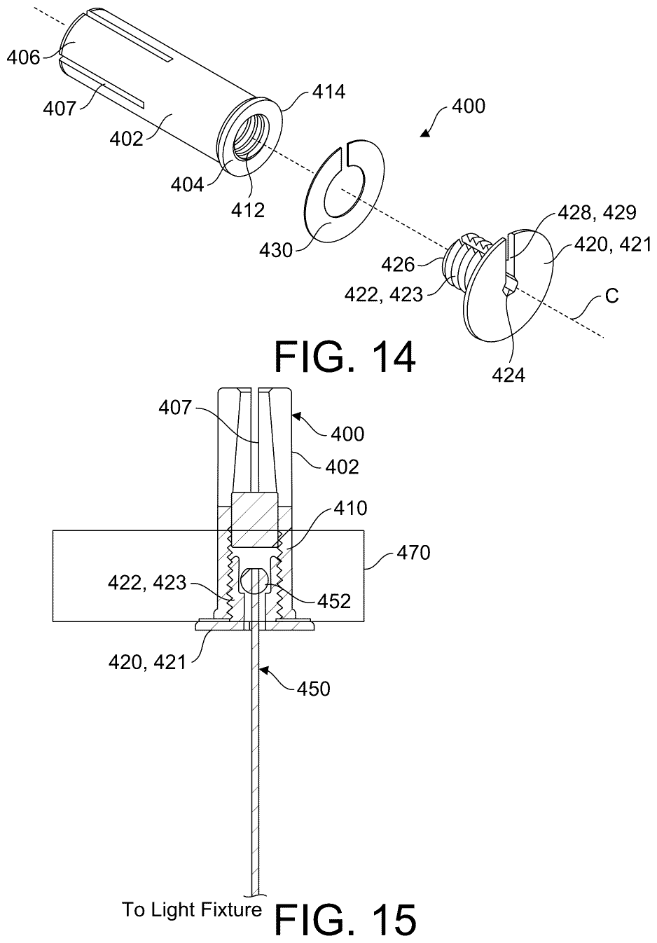

Turning now to FIGS. 14 and 15, a mounting device 400 for concrete structures is shown. The mounting device 400 has a hollow housing 402 that has an entrance end 404 and an anchoring end 406, which has a plurality of spaced apart longitudinal slits 407, and interior threads 410 configured to receive a canopy 420. The hollow housing 402 can also have a radially protruding, annular flange 414 on the entrance end 404. The annular flange 414 can determine or limit the mounting depth for the hollow housing 402, by seating the annular flange 414 against a building material or substrate 470 shown in FIG. 15. The hollow housing 402 can be generally cylindrical or its exterior shape can be a frustum of a cone.

The mounting device 400 has a flat planar canopy 420 as a head 421 of a threaded stem 422 having threads 423. The canopy 420 has a bore 424 therethrough in the longitudinal direction, see the longitudinal axis C. The bore 424 is aligned with the longitudinal axis and has a distal end 426 opposite the head 421, which defines the first end of the screw-like structure. The canopy 420 comprises a recess 428 shaped to receive a tool for rotating the threaded stem, which in this embodiment is shown as a slot 429 extending radially outward from the bore 424. As best seen in FIG. 14, the slot 429 can extend axially through the entire body of the canopy 421. The slot 429 is configured to receive the tip of a flathead screwdriver or the like to aid in installation.

The mounting device 400 can also include an annular pad 430 seatable against the annular flange 414 of the hollow body 402 before the canopy 420 is threadingly inserted therein. In one embodiment, the annular pad 330 is made of the possible materials noted above.

Turning now to the installed and assembled view of FIG. 15, the housing 402 lacks threading and as such is pushed or hammered into a hole in the substrate 470. Once inserted, a pin can be inserted into the hollow housing 402 and hit with a hammer to deform the anchoring end 406 into an increased diameter, thereby forming a friction fit with the substrate. Next, the threaded stem 422 of the screw-like member is threadingly engaged with the interior threads 410 of the hollow housing 402. The bore 424 is generally hexagonally-shaped to receive an aircraft cable 450, which is described above. The aircraft cable 450 has a ball at its first end, the end seated in the mounting device, and has a grip lock feature (not shown) at its second end, which is connectable to a pendant light's hardware. Since the aircraft cable 450 has the ball 452 at its first end, the slot 429 in the canopy 420 may also enable the aircraft cable to be inserted into the canopy. Alternately, the mounting device 400 can be used in the same manner as described above with respect to the embodiment of FIGS. 9 and 10 if class 2 or class 3 power wiring is needed.

The mounting devices 300 and 400 may be referred to as a flush mount or low profile swag anchor.

In one aspect, methods of installation are disclosed using either of the devices described herein. The method includes drilling a hole in the building material and running electrical wiring to the hole, the feeding the wire through the hollow housing beginning at its second end, then threading the hollow housing into the hole in the building material. Next the method includes attaching the wires of the electrical wiring to the strain relief hook or strain relief cartridge and then each wire to a wire connector, such as a wire cap or a WAGO brand connector. The method also includes feeding the wiring for an electrical device through the borehole in the cap or canopy and connecting it in electrical communication with the wiring fed to the hold in the building material using a wire cap or the WAGO brand connector, and then thread the cap or canopy to the hollow housing.

In some embodiment for installing the hollow housing, the method may vary slightly, in that the wiring may be fed through the cap after it has been threadingly inserted into the hollow housing or slid into a slot of the cap before being threadingly inserted into the hollow housing. The wiring can then be connected for electrical communication with other wiring.

The methods disclosed herein can also include forming a countersink recess in the substrate to receive the faceplate for a flush mount thereto, relative to the hole cut to receive the hollow housing.

The mounting devices and systems herein provide flexibility in installation by being compatible with many standard substrate materials, such as drywall, wood, tile, paneling, cement or cement board, fiber board, stucco, etc. and providing adaptability across a wide range of architectural contexts, i.e., the surfaces do not necessarily have to be flat. The small footprint of the mounting device allows this to be placed onto curved or uneven architectural surfaces easily and guarantees a high quality finish regardless of support beam placements. The low-profile faceplate results in an unobtrusive installation that does not protrude from the wall, ceiling, floor, or other surface, thereby fitting into the desired aesthetic, whether residential, commercial, or a public space. The mounting devices are ideal for mounting various electrical fixtures in residential settings without compromising the room's aesthetics. The mounting devices are well suited for use in offices, conference rooms, and retail spaces where a sleek and unobtrusive appearance is desired. The mounting devices are perfect for venues such as auditoriums, theaters, and museums where low visual impact and ease of maintenance are essential. The low-profile faceplate of the mounting devices disclosed herein redefine installation simplicity for interior spaces, aesthetic integration, maintenance accessibility, and design sophistication.

The processes and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed. Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.” It will be understood that although the terms “first,” “second,” “third,” etc. may be used herein to describe various layers, elements, components, regions, or sections without referring to any particular order or sequence of events. These terms are merely used to distinguish one layer, element, component, region or section from another layer, element, component, region, or section. A first layer, element, component, region, or section as described herein could be referred to as a second layer, element, component, region, or section without departing from the teachings of the present disclosure. As used herein, the term “or” is used inclusively to refer items in the alternative and in combination.

Embodiments of the present disclosure have been shown and described as set forth herein and are provided by way of example only. One of ordinary skill in the art will recognize numerous adaptations, changes, variations, and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A mounting device for an electrical fixture comprising:
a hollow housing having an entrance end and an opposing exit end, exterior threading configured to engage a building material, and interior threads; and
a faceplate as a head of a threaded stem, wherein the threaded stem has a bore therethrough in the longitudinal direction, and the threaded stem is threadingly engaged with the interior threads of the hollow housing.

2. The mounting device of claim 1, wherein the hollow housing is shaped as a frustum of a cone.

3. The mounting device of claim 1, wherein the distal end of the threaded stem extends beyond the opposing exit end.

4. The mounting device of claim 3, further comprising a wire passing through the bore of the threaded stem and a strain relief collar connected to the wire and seated against the distal end of the threaded stem.

5. The mounting device of claim 4, wherein the strain relief collar has an elongate body defining a through hole having a plastic insert seated therein, wherein the elongate body has a threaded hole oriented transverse to a longitudinal axis thereof and a set screw threaded into the threaded hole.

6. The mounting device of claim 5, wherein the plastic insert comprises a radially outward extending flange at a first end which is seated against a first end of the elongate body.

7. The mounting device of claim 4, wherein the wire terminates with an electric outlet configured to receive a plug of an electrical light or electrical light fixture.

8. The mounting device of claim 1, wherein the faceplate comprises a recess shaped to receive a tool for rotating the threaded stem.

9. The mounting device of claim 1, wherein the faceplate is a low-profile canopy for a light fixture.

10. A mounting device for an electrical fixture comprising:
a hollow housing defining a cavity and having a first end comprising interior threads and an opposing second end having a through hole, and having exterior threads configured to engage a building material;
an insulating lining in the cavity;
a strain relief collar seated in the cavity and operatively connected to a wire or cable for an electrical fixture;
a wiring connector; and
a cap comprising a faceplate having a threaded stem protruding therefrom that is removably threaded to the interior threads of the hollow housing, wherein the threaded stem has a bore therethrough in the longitudinal direction.

11. The mounting device of claim 10, wherein the faceplate comprises a recess shaped to receive a tool for rotating the threaded stem of the cap.

12. The mounting device of claim 10, wherein the insulting lining is a coating applied to the interior surface of the mounting cavity.

13. The mounting device of claim 10, wherein the insulting lining is an insert that is seated against the interior surface of the mounting cavity.

14. The mounting device of claim 13, wherein the insert is contoured to mate with the interior surface of the mounting cavity and has an aperture aligned with the through hole of the second end.

15. The mounting device of claim 13, wherein the insert comprises an elastomeric material.

16. The mounting device of claim 13, wherein the insert terminates with an inward tapered neck that has an annular collar extending therefrom.

17. The mounting device of claim 10, wherein the strain relief collar has an elongate body defining a through hole having a plastic insert seated therein, wherein the elongate body has a threaded hole oriented transverse to a longitudinal axis thereof and a set screw threaded into the threaded hole.

18. The mounting device of claim 17, wherein the plastic insert comprises a radially outward extending flange at a first end which is seated against a first end of the elongate body.

19. The mounting device of claim 17, wherein the electrical wire is a class 2 or class 3 power electrical wire.
